(19) United States
(12) Patent Application Publication
(10) Pub. No.: US 2025/0337453 A1
(43) Pub. Date: Oct. 30, 2025

(54) AMBIENT POWER COMMUNICATION

(71) Applicant: NXP USA, Inc., AUSTIN, TX (US)

(72) Inventors: Rui Cao, Sunnyvale, CA (US); Xilin Cheng, Menlo Park, CA (US); Hongyuan Zhang, Fremont, CA (US); Sergey Timofeev, Mountain View, CA (US); Zheng Guo, Newark, CA (US)

(21) Appl. No.: 19/187,076

(22) Filed: Apr. 23, 2025

Related U.S. Application Data
(60) Provisional application No. 63/637,992, filed on Apr. 24, 2024.
(60) Provisional application No. 63/685,985, filed on Aug. 22, 2024.
(60) Provisional application No. 63/690,727, filed on Sep. 4, 2024.
(60) Provisional application No. 63/719,505, filed on Nov. 12, 2024.
(60) Provisional application No. 63/785,902, filed on Apr. 9, 2025.

(51) Int. Cl. H04B 1/707; H02J 50/80; H04L 5/00

(52) U.S. Cl. CPC H04B 1/707; H04L 5/0007; H04L 5/0048; H02J 50/80

(57) ABSTRACT

Ambient power (AMP) communication by a WiFi reader is transmitted by generating a preamble of a physical layer protocol data unit (PPDU), the preamble compliant with Institute of Electrical and Electronics Engineers (IEEE) 802.11; generating a downlink segment of the PPDU, wherein the downlink segment includes a downlink SYNC field and modulated carrier symbols carrying downlink data; generating an uplink segment of the PPDU, wherein the uplink segment includes reference symbols which the WiFi reader uses to performs signal leakage estimation and carrier symbols, wherein an AMP tag device is arranged to backscatter a waveform based on the carrier symbols; and transmitting, by the WiFi reader, the PPDU to the AMP tag device.

### CROSS-REFERENCE TO RELATED APPLICATIONS

This application claims the benefit of U.S. Provisional Patent Application Ser. No. 63/637,992 entitled “MODULATION AND DETECTION FOR AMBIENT POWER WIFI BACKSCATTERING” filed Apr. 24, 2024, U.S. Provisional Patent Application Ser. No. 63/685,985 entitled “AMBIENT POWER WIFI DOWNLINK WAVEFORM DESIGN” filed Aug. 22, 2024, U.S. Provisional Patent Application Ser. No. 63/690,727 entitled “AMBIENT POWER WIFI DOWNLINK WAVEFORM AND PPDU DESIGN” filed Sep. 4, 2024, U.S. Provisional Patent Application Ser. Number 63/719505 entitled “AMBIENT POWER WIFI DOWNLINK WAVEFORM AND PPDU DESIGN” filed Nov. 12, 2024, and U.S. Provisional Patent Application Ser. No. 63/785,902 entitled “AMBIENT POWER WIFI DOWNLINK WAVEFORM DESIGN” filed Apr. 9, 2025, the contents each of which are incorporated herein by reference in its entirety.

### FIELD OF USE

The present disclosure relates generally to data communication, and more particularly, to a system, method, and apparatus for ambient power communication based on Institute of Electrical and Electronics Engineers (IEEE) 802.11 bp.

### BACKGROUND

Ambient power (A M P) communication is proposed in Institute of Electrical and Electronics Engineers (IEEE) 802.11.bp. AMP communication enables low power operation of AMP tag devices by battery-less backscattering in a 2.4 GHz range compared to low power operation of radio frequency identifier (RFID) devices which perform battery-less backscattering in a ultra-high frequency (UHF) 860-940 MHz range.

### BRIEF DESCRIPTION OF THE DRAWINGS

The following detailed description of the preferred embodiments of the present disclosure will be better understood when read in conjunction with the appended drawings. The present disclosure is illustrated by way of example, and not limited by the accompanying figures, in which like references indicate similar elements.

FIG. 1 illustrates an example block diagram of an ambient power (AMP) communication system in accordance with one or more embodiments.

FIG. 2 illustrates example physical layer protocol data units (PPDUs) to be transmitted to an AMP tag device and which coexists with legacy WiFi devices in accordance with one or more embodiments.

FIG. 3 illustrates in more detail an example preamble and AMP portion of a PPDU in accordance with one or more embodiments.

FIG. 4 illustrates an example PPDU in accordance with one or more embodiments.

FIG. 5 illustrates another example PPDU in accordance with one or more embodiments.

FIG. 6 illustrates an example plurality of frequency bins corresponding to subcarriers of an OFDM symbol of the PPDU in accordance with one or more embodiments.

FIG. 7 is an example flow chart of functions associated with the WiFi reader generating and transmitting the PPDU to the AMP tag device in accordance with one or more embodiments.

### DETAILED DESCRIPTION

The detailed description of the appended drawings is intended as a description of the currently preferred embodiments of the present disclosure, and is not intended to represent the only form in which the present disclosure may be practiced. It is to be understood that the same or equivalent functions may be accomplished by different embodiments that are intended to be encompassed within the spirit and scope of the present disclosure.

Embodiments disclosed herein are directed to a physical layer protocol data unit (PPDU) format associated with ambient power (AP) communication with an AMP tag device that is able to co-exist with legacy WiFi devices in a WiFi network. Well known instructions, protocols, structures, and techniques have not been shown in detail in order not to obfuscate the description.

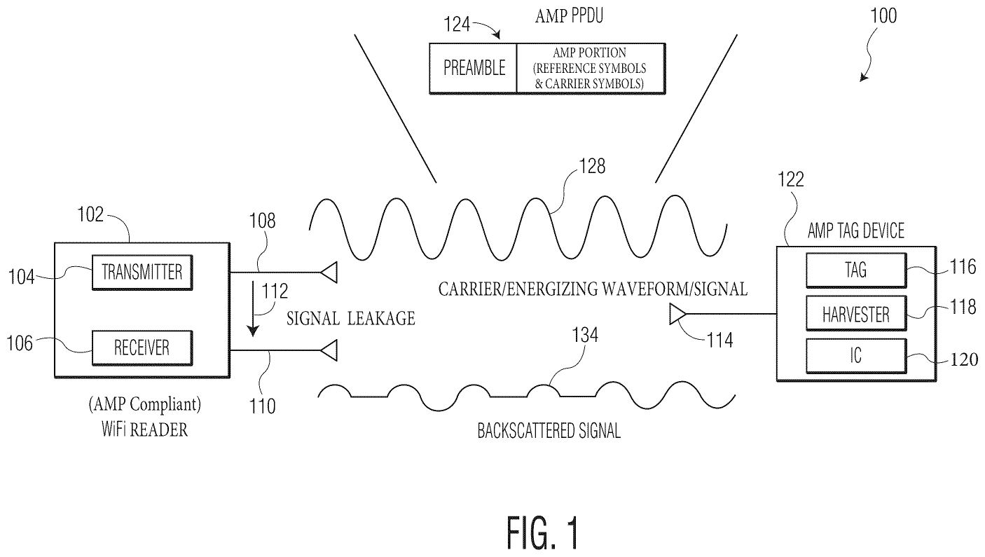

FIG. 1 illustrates an example block diagram of an ambient power (AMP) communication system 100 in accordance with one or more embodiments. The AMP communication system 100 may include an AMP tag device 122 and a WiFi reader 102 that is AMP compliant and may operate to read (and in some cases write) data from/to the AMP tag device 122. The AMP tag device 122 and WiFi reader 102 may be implemented by one or more of analog circuitry, mix signal circuitry, memory circuitry, logic circuitry, and processing circuitry that executes code stored in a memory to perform disclosed functions on one or more integrated circuits.

The AMP tag device 122 may be a device compatible with Institute of Electrical and Electronics Engineers (IEEE) 802.11.bp. In one or more embodiments, the AMP tag device 122 may be a battery-less backscattering tag device operable in one or more sub-bands, such as sub-1 GHz and 2.4 GHz (or general sub-7 GHz) and have one or more antenna 114 for transmitting or receiving in the band. The AMP tag device 122 is typically low-cost and has an energy efficient design by using a low cost voltage controlled oscillator (VCO) with no crystal and phase lock loop (PLL). The AMP tag device 122 may also have an integrated circuit (IC) 120 to facilitate transmitting or receiving signals in the one or more bands without a battery based on timing of the VCO. The received signal may indicate a request from the WiFi reader 102 to read or write data in a memory of the AMP tag device 122 also referred to as tag 116 and the transmitted signal may indicate data stored in the tag 116 or a response to the write operation. The AMP tag device 122 may have a harvester 118 which extracts power from a waveform 128 transmitted by the A M P-compliant WiFi reader 102 and incident on the antenna 114 to operate the integrated circuit (IC) 120 to receive and transmit signals. In one or more embodiments, the waveform 128 may be a carrier waveform or energizing waveform on which the data transmitted by the WiFi reader 102 is modulated, and on which the AMP tag device 122 backscatters data by modulation to define the signals transmitted by the AMP tag device 122. To transmit and receive the signals, the WiFi reader 102 may have a transmitter 104, receiver 106 and one or more antenna such as respective antenna 108, 110. The WiFi reader 102 may take the form of a smart phone, smart home hub, public transportation hotspot, etc. compatible with Institute of Electrical and Electronics Engineers (IEEE) 802.11n, 802.11bn, 802.11 bp and various other iterations of the 802.11 specification referred to herein including but not limited to IEEE 802.11ac, IEEE 802.11be, and IEEE 802.11ax. IEEE 802.11ac is referred to as very high throughput (VHT). IEEE 802.11ax is referred to as high efficiency (HE). IEEE 802.11n is referred to as high throughput (HT). IEEE 802.11be is referred to as extreme high throughput (EHT). IEEE 802.11bn is referred to as ultra-high reliability (UHR).

The WiFi reader 102 operates to transmit and receive WiFi signals in addition to signals transmitted for the operation of the AMP tag device 122. To achieve co-existence with other legacy WiFi devices (e.g., devices which do not support AMP communication), the WiFi reader 102 is arranged to transmit the waveform 128 to the AMP tag device 122 in the form of a physical layer protocol data unit (PPDU) 124 having symbols that represent one or more bits and that define a legacy WiFi preamble, e.g., 802.11b or legacy orthogonal frequency division multiplexed (OFDM) preamble (e.g., 802.11 11g/n/ac/ax/be), and a payload of the PPDU. By including the legacy preamble, the PPDU 124 is configured to allow for other WiFi readers or legacy WiFi devices (not shown and not AMP compliant) to be able to decode the legacy preamble of the PPDU 124 and backoff from transmitting for the duration of the PPDU 124 as indicated by the preamble so as not to interfere with AMP communication between the WiFi reader 102 with the AMP tag device 122.

In one or more embodiments, the WiFi reader 102 may read data from the tag 116 or write data to the tag 116 by transmitting the PPDU 124. The PPDU 124 transmitted as the waveform 128 is incident on the antenna 114 of the AMP tag device 122. The harvester 118 of the AMP tag device 122 may harvest power from the waveform 128 defining the PPDU 124 to power the IC 120 to receive and decode symbols in an AMP portion of the PPDU which is in the payload of the PPDU 124. Based on the symbols that are decoded in the PPDU 124, the IC 120 may cause the AMP tag device 122 perform the read or write operation and transmit a response. The AMP tag device 122 may transmit the response by a backscattering process which involves modulating a portion of the waveform 128 incident on the antenna 114 to generate a backscatter signal 134. Impedance of the antenna 114 may be modulated based on bits of the response to modulate an amount of incident RF energy and scatter the amount of incident energy on the antenna 114 to transmit bits of the response from the AMP tag device 122 to the WiFi reader 102 as backscattering. The response may be the data stored in the tag 116 or a protocol compliant response control message. The WiFi reader 102 will then receive this backscatter signal 134. In some embodiments, the WiFi reader 102 may further send an acknowledgement to indicate the receipt of the response or uplink communication.

The modulation clock accuracy of AMP tag device 122 will be very limited, e.g., 100,000 parts per million (ppm) variation because of the low cost design. The ppm may be measure of a variation of modulation accuracy such as a 1 Hz change in frequency for every 1 MHz of frequency. Further, complexity associated with the reading of data may need to be put onto the WiFi reader 102 which needs to resolve a large sampling frequency offset (SFO) of the VCO of the AMP tag device 122.

In one or more embodiments, the WiFi reader 102 may need to send a well-designed waveform 128 to define the PPDU 124. The waveform 128 may be the carrier waveform with a repeated base waveform. This way, signal leakage 112 from transmit antenna 108 to receive antenna 110 due to antenna coupling can be removed and the backscattered signal received by the WiFi reader 102 is able to be decoded with better signal-to-interference-and-noise ratio (SINR). The antenna coupling may be leakage of the transmitted signal transmitted by the transmitter 104 received at the receiver 106. The waveform 128 may have defined design criteria such as a low peak to average power ratio (PAPR) to enable higher transmit power and better receive signal-to-noise ratio, a low power fluctuation for a duration of every symbol for which on-off keying (OOK) modulation is applied for backscattering, and small spectral leakage due to the OOK. For 250 kbps OOK with Manchester encoding, a symbol duration is 2 us while for 1 mbps OOK with Manchester encoding, a symbol duration is 0.5 us. The OOK with Manchester encoding is a method of transmitting data where the waveform 128 is either on or off to represent a ‘1’ or ‘0’ bit, and the Manchester encoding ensures a transition occurs at the start of each bit period, aiding clock recovery and data integrity.

Signal leakage 112 has a high power and a same timing as the waveform 128 and the backscatter signal 134 received at the receiver 106 of the WiFi reader 102 may be masked by the signal leakage 112 which typically has a higher power. The WiFi reader 102 needs to remove this signal leakage 112 from a received signal at the receiver 106 to recover the backscattered signal 134 using a leakage estimation and removal process. Many ways for removing this signal leakage 112 are possible.

In one or more embodiments, a leakage in an Nth symbol of the PPDU 124 that is received where N is an integer may be removed by subtracting a waveform of the N-1th symbol that is already received from a waveform of the Nth symbol. The differencing may reduce the signal leakage 112 but could result in destroying the Nth symbol modulation. In one or more embodiments, the WiFi reader 102 may transmit reference symbols in the PPDU 124 and determine leakage of the reference symbols between the transmitter 104 and the receiver 106. The reference symbols may be predefined symbols such as orthogonal frequency division multiplexed (OFDM) symbols that represent a predefined data sequence. Then, the WiFi reader 102 may transmit subsequent carrier symbols which the AMP tag device 122 receives in the PPDU 124. The AMP tag device 122 may receive the PPDU 124 and modulate data on a waveform of the carrier symbols based on backscattering to transmit data back to the WiFi reader 102 and the modulation parameters are determined based on control information in an AMP portion of the PPDU such as AMP data transmitted to the AMP device 122 which also includes a synchronization pattern and the reference symbols in some embodiments. The reference symbols may have a same format and content as the carrier symbols except for some phase or polarity differences while the AMP tag device 122 will not backscatter any data within the duration of the reference symbols to allow for accurate signal leakage 112 determination. In some embodiments, the AMP tag device 122 may backscatter data bits to the WiFi reader 102 a predetermined time after sending the carrier symbols to allow for the WiFi reader 102 to estimate the signal leakage 112 based on the carrier symbols received during the non-backscattering time by the receiver 106. The WiFi reader 102 may receive the combined signal leakage 112 and backscattering signal 134 and then subtract the estimated signal leakage 112 based on reference symbols from the received signal to remove the signal leakage 112 and recover the backscatter signal 134 without the signal leakage 112.

In one or more embodiments, the WiFi reader 102 may send reference symbols periodically in the PPDU 124 and instruct the AMP tag device 122 to skip performing a backscattering every N reference symbols for the WiFi reader 102 to determine the signal leakage 112. The estimation process may include estimating the reference symbols which are received based on the transmitted reference symbols to estimate the signal leakage 112. Then, the WiFi reader 102 may subtract at the receiver 106 the estimated signal leakage 112 based on the reference symbols from a received signal to recover the backscatter signal 134 and remove the signal leakage 112. The periodic sending of the reference symbols or determining the signal leakage 112 allows for improving the signal leakage 112 estimation and recovery of the backscattered signal with higher signal-to-noise ratio.

In one or more embodiments, the portion of the waveform 128 that defines the reference symbols associated with leakage estimation and the carrier symbols that are backscattered may not be simple repeated symbols that cause a spectrum spike and violate transmit requirements. The portion of the waveform 128 may also be a known waveform that is received at the receiver 106 for signal leakage 112 estimation. The phase or polarity on the portion of the waveform 128 for signal leakage 112 estimation may need to be removed to perform the carrier symbol leakage estimation. In one or more embodiments, the portion of the waveform 128 may be an existing WiFi single-carrier waveform, e.g., defined by IEEE 802.11b. The receiver 106 may need to remove any modulation (e.g., differential binary phase shift keying (DBPSK)) of 802.11b from the reference symbol portion of the waveform 128, estimate the leakage signal of the reference symbols, and regenerate carrier symbols with modulation recovered for signal leakage 112 removal. As a result, a waveform of the regenerated carrier symbols is subtracted from a received signal at the receiver 106 to recover the backscattered signal 134 resulting from backscattering a waveform of carrier symbols in the PPDU 124 for signal leakage 112 removal. In one or more embodiments, the portion of the waveform 128 defining the reference symbols may be an existing OFDM waveform, e.g., defined by IEEE 802.11g/n/ac/ax/be. The receiver 106 may need to remove any loaded information in a frequency domain to estimate the signal leakage 112 and regenerate the carrier symbols with modulation for signal leakage 112 removal.

In one or more embodiments, the PPDU 124 defined by the waveform 128 may be a 802.11b PPDU with a fixed pattern in the AMP portion, e.g. all 0's or all l's based on a fixed scrambling seed to define the reference symbols for detecting and cancelling the signal leakage 112. In one or more embodiments, the PPDU 124 defined by the waveform 128 may be an OFDM PPDU 124 defined by 802.11g/n/ac/ax/be with a same OFDM symbol repeated as an AMP portion of the PPDU such as long training field (LTF) symbols, random data OFDM symbols, or padding symbols with end of frame (EOF) padding content. The AMP portion may include the reference symbols for estimating carrier symbols at the receiver and used for cancelling the signal leakage 112 from the received signal at the receiver 106 to recover the backscattered signal generated based on the carrier symbols. Each OFDM symbol may be modulated with a pre-defined scrambling phase. For example, the scrambling phase is based on a pseudorandom number (PN) sequence such as a 7-bit PN sequence, and the PN sequence may define a unique 128 bit sequence with varying −1, +1 polarities used for the scrambling. Other types of symbols in AMP portion may be the carrier symbols.

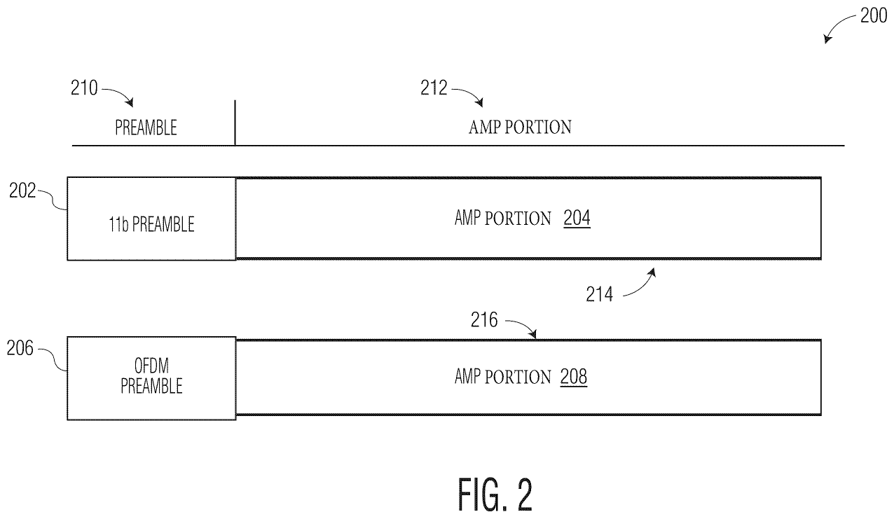

FIG. 2 illustrates example PPDUs 200 to be transmitted by the WiFi reader 102 to an AMP tag device 122 and which coexists with legacy WiFi devices in accordance with one or more embodiments. The PPDU 214 may include a preamble 202 followed by an AMP portion 204 of the PPDU 214. The PPDU 216 may include a preamble 206 followed by the AMP portion 208. The preamble 202 may be a 802.11b preamble while the preamble 206 may be an OFDM preamble 206 defined by 802.11g/n/ac/ax/be. The PPDU 214, 216 may be transmitted to an AMP tag device 122. For example, the AMP portion 204, 208 may carry carrier symbols modulated by the WiFi reader 102 with data to be transmitted to the AMP tag device 122. Additionally, the AMP portion 204, 208 may include carrier symbols which are not modulated by the WiFi reader 102 and whose waveform is to be backscattered by the AMP tag device 122 to transmit data back to the WiFi reader 102 as the backscatter signal 134. The AMP portion 208 may be formatted as repeated OFDM symbols. The AMP portion 208 may be a narrow band such as 2-4 MHz formatted as a single carrier 802.11b data or equal or smaller than 20 MHz compared to a 20 MHz bandwidth of the preamble 206. The AMP portion 204 may be formatted as 802.11b data. In one or more embodiments, the signal bandwidth of the 802.11b PPDU 214 may be uniform across a PPDU as a 22 MHz bandwidth.

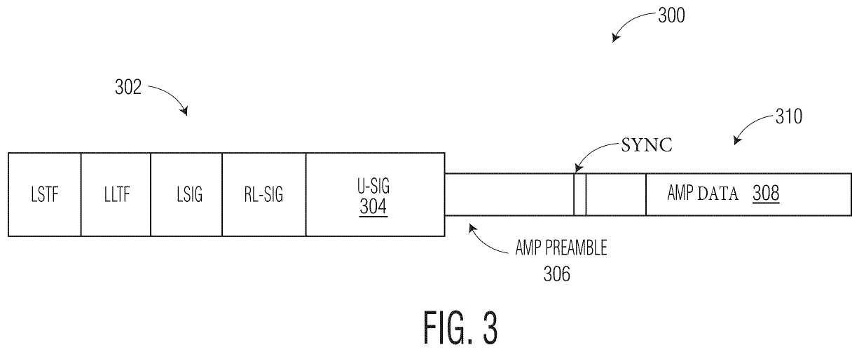

FIG. 3 illustrates in more detail an example preamble 302 and AMP portion 310 of a PPDU 300 in accordance with one or more embodiments. The AMP portion 310 may be a portion of the waveform 128 and serve a purpose of downlink data transmission from the WiFi reader 102 to the AMP tag device 122. The preamble 302 of the OFDM preamble may indicate a duration of the entire PPDU 300 which includes the preamble 302 and A M P portion 310 and includes a plurality of fields. The preamble 302 may include a legacy short training field (L-STF), a legacy long training field (L-LTF), a legacy signaling field (L-SIG), a repeated legacy signaling field (RL-SIG), and a universal signaling field (U-SIG). In some embodiments, a second STF (not shown) may follow the U-SIG field. A L LENGTH field in the legacy signaling field (L SIG) of the preamble 302 may indicate the duration. In some examples, a U-SIG (universal signaling) field 304 associated with 802.11be EHT may be in the preamble 302 and the U-SIG field 304 may indicate the duration. Additionally, the U-SIG 304 may have a PPDU identification that indicates the PPDU type is associated with AMP communication. The U-SIG 304 may include a plurality of fields such as a Validate mode, PPDU type, and Compression mode. In one option, one Validate mode of a plurality of modes in the U-SIG may be used to indicate the type of PPDU is associated with AMP communication. In another option, a PHY version identifier=0 and PPDU Type and Compression Mode=3 or PHY version identifier=0 and one Validate=0 may be set to indicate the type of PPDU is associated with AMP communication. In yet another option, a new PHY version value is set different from EHT and UHR in the U-SIG 304 such as PHY version Identifier=2 in the U-SIG 304 to indicate the type of PPDU is associated with AMP communication. The U-SIG 304 may also identify a basic service set (BSS) Color, transmit opportunity (TX OP), indication of downlink/uplink (DL/UL) communication, and bandwidth (BW) set for coexistence with other WiFi readers that receive the PPDU, and other fields can be reserved for other uses.

In one or more embodiments, the AMP portion 310 may include an AMP preamble 306 and AMP data 308. The AMP preamble 308 may have a synchronization (SY NC) field for the AMP tag device 122 to detect the preamble 306 and synchronize and calibrate reception of the AMP data 308 which is transmitted by the WiFi reader 102 to the AMP tag device 122. In some embodiments, an OFDM based symbol may be used for generating the carrier symbols for the AMP portion 310. Some predefined sequence may be used to generate the OFDM symbol, e.g., LTF symbols or padding symbols. In some embodiments, an 802.11b direct spread spectrum sequence (DSSS) based waveform may be used for generating the AMP portion 310 of the PPDU 300. A narrow bandwidth may be generated by a new DSSS spreading code rather than a 11-chip Barker spreading code associated with 802.11b resulting in a narrower signaling bandwidth, e.g. 1 MHz. In some embodiments, the 11-chip spreading code is designed with less transitions, resulting in a narrower bandwidth, e.g., [1 1 1 1 0 0 0 0 1 1 1]. As another example, the DSSS spreading code may be set to all 1's resulting in a narrower bandwidth of 1 MHz. Further, the transitions in a direct spread spectrum sequence (DSSS) waveform may be reduced to further reduce a bandwidth of the AMP portion 310, such as by 11× downclock to 2 MHz or 1.1× down clock to 20 MHz which reduces a clocking rate of data written to the PPDU to reduce a bandwidth of the AMP portion 310. In some embodiments, the AMP portion 310 may be a fixed predefined pattern, e.g. all one values which is then scrambled with a scrambling seed. If the AMP portion 310 contains a downlink control frame that is transmitted to the AMP tag device 122, on off keying (OOK) modulation is performed on the carrier symbols of A M P portion 310 to carry AMP data 308 from the WiFi reader 102 to the AMP tag device 122. If the AMP portion 310 contains carrier symbols to the AMP tag device 122 to energize the AMP tag device 122 or for the AMP tag device 122 to perform backscattering, no modulation may be applied to the AMP portion 310 by the AMP tag device 122. In one or more embodiments, OOK modulation is applied on every N symbols of the DSSS waveform for the WiFi device 102 to convey data, where the symbol is a spreading code waveform. In one or more embodiments, N=1 for 1 M bps data rate; N=2 for 500 Kbps data rate; N=4 for 250 kbps data rate. In some embodiments, an 802.11ba (wakeup radio) waveform is used as a format of the AMP portion 310.

A “NAV clock” in the context of WiFi refers to a mechanism within the WiFi protocol (IEEE 802.11) called the “Network Allocation Vector” which acts like a virtual timer, allowing a WiFi reader 102 to predict when the wireless channel will be free so that the WiFi reader 102 is able to transmit data. During this time, no other WiFi readers or WiFi devices should transmit so as not to interfere with the transmitted data to the AMP tag device 122. The AMP tag device 122 may only support receiving smaller bandwidth transmissions in the AMP portion 310 that WiFi readers 102 or legacy WiFI devices cannot decode, and thus the NAV clock may not properly indicate when the wireless channel is free. In one or more embodiments, the WiFi reader 102 that is transmitting the PPDU 300 to the AMP tag device 122 may send a clear to send (CTS) to self to cause other WiFi readers and WiFi devices to backoff transmitting during this time, or set the transmit opportunity (TX OP) value in the U-SIG 304 which is received by the other WiFi readers and WiFi devices to cause the other WiFi readers and devices to backoff transmitting during this time.

In some embodiments, the WiFi reader 102 may transmit a postamble in the PPDU to cause other WiFi readers and devices to continue to backoff transmission along with carrier symbols for the A P tag device 122 to transmit data back to the WiFi device 102 by backscattering.

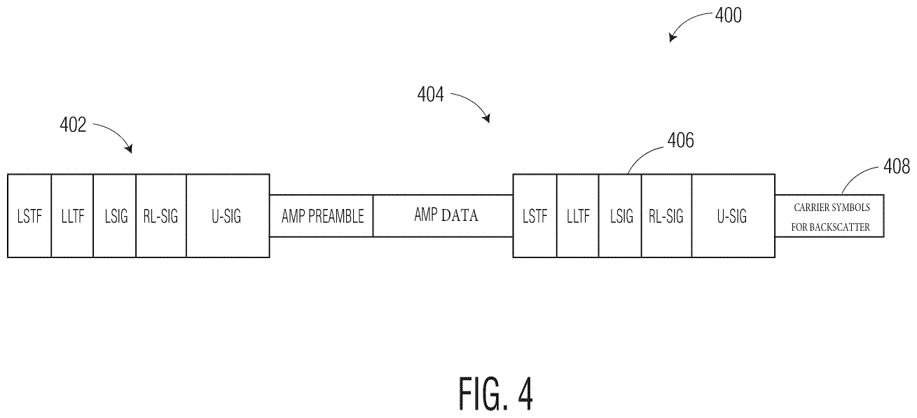

FIG. 4 illustrates an example PPDU 400 with postamble 406 in accordance with one or more embodiments. The PPDU 400 may include a preamble 402 and an AMP portion 404 which includes the AMP preamble, AMP data for downlink transmission, the postamble 406, and carrier symbols 408. In one or more embodiments, the postamble 406 which takes the form of the legacy preamble (up to U-SIG 304) can be transmitted to protect from other WiFi readers transmitting for a period of time after the postamble 406 is transmitted. The U-SIG in the postamble 406 may indicate a length value so that WiFi readers that decode the U-SIG will not transmit for the indicated length value which may include a time for the AMP tag device 122 to perform backscattering of a waveform of the carrier symbols 408 also in the AMP portion 404 to transmit data in an uplink direction back to the WiFi reader 102. Further, WiFi readers and legacy WiFi devices that cannot decode U-SIG in the postamble 406 may use the L LENGTH in the L-SIG of the postamble 406 to determine the length value. The legacy WiFi devices may not transmit for a time associated with the length value to allow the AMP tag device 122 to transmit in the uplink direction. In one or more embodiments, the postamble 406 is a distinguishable pattern from any OOK modulated waveform.

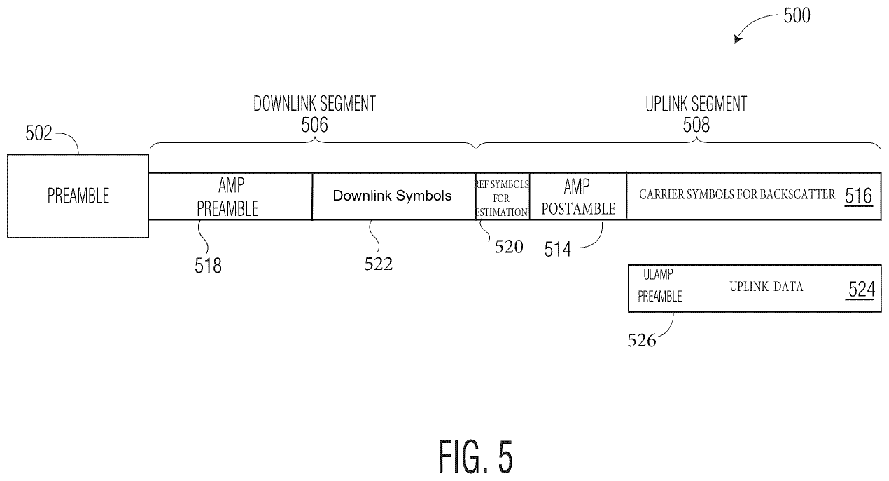

FIG. 5 illustrates another example PPDU 500 in accordance with one or more embodiments. The PPDU 500 may have a preamble 502, a downlink segment 506 and an uplink segment 508. The preamble 502 is interoperable with legacy WiFi devices, and may take a format as shown and described by example preambles 202, 206, 302 or 402. The downlink segment 506 may be generated by the WiFi reader 102 to transmit data from the WiFi reader 102 to the AMP tag device 122 and include an AMP preamble 518 and carrier symbols 522 which are modulated by the WiFi reader 102 to carry the data transmitted to the AMP tag device 122. The uplink segment 508 may be used by the AMP tag device 122 to transmit data to the WiFi reader 102 by backscattering. The uplink segment 508 may have reference symbols 520 for leakage estimation, an AMP postamble 514, and carrier symbols 516 for backscattering by the AMP tag device 122. The AMP postamble 514 may have a synchronization pattern. A waveform of the carrier symbols 516 may not be modulated with data by the WiFi reader 102 and instead be modulated by the AMP tag device 122 by backscattering to transmit data to the WiFi reader 102. The postamble 514 may be transmitted by the WiFi reader 102 and used by the AMP tag device 122 to explicitly detect the start of the carrier symbols for backscattering and synchronize an OOK modulated signal boundary to address the issue of tag time drift due to high clock ppm. The data transmitted from the AMP tag device 122 to the WiFi reader 102 may be tag data stored in the AMP tag device 122 in an example. There may be more than one downlink segment and more than one uplink segment in PPDU 500. In some embodiments, an additional uplink segment 508 may be placed before the downlink segment 506 to energize the AMP tag device 122 before AMP communications, and no backscattering will be performed by the AMP tag device 122 while the AMP tag device 122 is being energized. For this usage, the reference symbols 520 and AMP postamble 514 may be skipped and not transmitted.

In some embodiments, the uplink backscattered transmission by the AMP tag device 122 may include an uplink AMP preamble 526 followed by uplink data 524 in field 516 of the uplink segment 508. Further, the UL AMP postamble 514 for uplink transmission may be orthogonal to the AMP preamble 518 for downlink (DL) transmission so that the AMP tag device 122 is triggered at a correct time to perform the backscatter. Further, the uplink (UL) AMP postamble 526 may be orthogonal to the AMP preamble 518 and the AMP postamble 514.

The AMP tag device 122 may transmit the tag data by modulating a waveform of the carrier symbols 516 transmitted by the WiFi reader 102 such as using OOK modulation to generate backscattering waveform that defines the uplink data 524 and which is then received by the WiFi reader 102. In one or more embodiments, reference symbols 520 for estimation of the signal leakage 112 may be transmitted before the carrier symbols 516 or as part of the carrier symbols 516. The reference symbols 520 which are transmitted by the WiFi reader 102 and then received at the receiver 106 may be used to estimate the signal leakage 112 of carrier symbols. In some embodiments, reference symbols 520 may precede symbols to be transmitted by the WiFi reader 102 in the downlink segment 506 (delaying transmission of the downlink symbols 522 for a reference time T) and the uplink AMP postamble 514 for signal leakage 112 estimation. The AMP tag device 122 may also not perform any backscattering for these reference symbols 520 so that the reference symbols 520 may be used to estimate signal leakage 112. In one or more embodiments, the WiFi reader 102 operating to read the tag data of the AMP tag device 122 may estimate the carrier symbols received at the receiver based on the received reference symbols 520 and remove the signal leakage 112 from the combined signal leakage 112 and backscatter signal 134 received at the receiver 106 by subtracting a waveform of the estimated carrier symbols from the backscattered signal.

In one or more embodiments, the carrier symbols in 516, 524 may have respective boundaries with a specified bandwidth that is smaller than legacy WiFi symbols. Further, if the PPDU is a 802.11b PPDU, the carrier symbols in 516, 524 of the AMP portion of the PPDU 500 may be generated by a scrambling of symbols so that a spectrum of the waveform 128 that defines the PPDU 500 does not have spikes. For any newly defined PPDU, the carrier symbols in 516, 524 may need a randomization of the polarity or phase of the symbols to mitigate spectrum spikes For example, a random +1/−1 polarity may be applied to each carrier symbol, e.g., the polarity generated with an existing scrambler (e.g., 7-bit or 11-bit) with predefined seed. Alternatively, a random N-phase shift keying (PSK) may be applied to each carrier symbol, e.g., generate random QPSK data which is modulated onto the sequence of carrier symbols in 516, 524.

Because of the high ppm of the AMP tag device 122, the modulation by the A M P tag device 122 may not be synchronized with symbol boundaries of the symbols in 516, 524. In one or more embodiments, a sliding correlator may be used to detect a timing boundary of each symbol as a result of the modulation. The sliding correlator calculates the correlation between a received signal and a correlation filter at different time offsets, effectively searching for modulation symbol boundaries of the received signal. The correlation filter is “slid” along the time axis of the received signal, meaning it is compared with different portions of the received signal at each time step. At each time step, the correlation between the correlation filter and the received signal is calculated. The resulting correlation values represent the “match” between the correlation filter and the received signal at different time delays and a maximum correlation indicates synchronization with a received symbol and timing boundary indicated by the correlation signal in determining the carrier symbol boundaries of the backscattered signal 134.

In one or more embodiments, the received symbol may have a single zero crossing and represent an information bit. The correlator filter may be a step function, e.g. [−1−1−1 . . . +1+1+1 . . . ], with a duration <=Tsym*(1+max_ppm/10⁻⁶) where Tsym is a duration of the symbol and max_ppm is a maximum ppm of the AMP tag device 122. The correlation may be performed over a maximum symbol period which accounts for variation in the duration of the symbol due to the ppm. When a correlation of the correlation filter and received signal is at maximum as a result of sliding the correlation filter over the time axis, the zero crossing point and spacing of the symbol indicates the boundary of the received symbol. In addition, the ppm may also be estimated based on the boundary detection of multiple information symbols, training symbols, or preamble symbols in the PPDU. From the preamble, the WiFi reader 102 may estimate the ppm value and SFO compensation can be performed at the WiFi reader 102. Further, the length of the correlation filter can be longer to enhance detection SNR. In one or more embodiments, a bank of correlation filters with different lengths may be used to detect the boundary of each received symbol to find the correlation filter providing maximum correlation and symbol boundary detection. Each correlator filter is a step function, e.g. [−1−1−1 . . . +1+1+1 . . . ], with different duration within (0, Tsym*(1+max_ppm/10⁻⁶)]. Further, a number of step functions used can be smaller to cover smaller inaccuracy range.

The waveform 128 may be generated based on carrier symbols in the form of OFDM symbols. In some embodiments, the OFDM symbols may have a random phase or a portion of the OFDM symbol may have a random phase. The OFDM symbol may have a varying duration.

In one or more embodiments, the carrier symbols may be based on a 4 us OFDM symbol. The OFDM symbol may include a plurality of subcarriers each represented by a respective frequency bin in a frequency domain that defines an amplitude of the subcarrier corresponding to the frequency bin. Data of a data sequence may be loaded into a respective frequency bin and an inverse Fast Fourier Transform of the data sequence in the frequency bins may be performed to generate a time domain OFDM symbol. When the data sequence is a LTF, the OFDM symbol may be an L-LTF symbol. When the data sequence is a HT/VHT LTF, the OFDM symbol may be an HT/VHT 20 MHz LTF symbol. When the data sequence is an HE/EHT/UHR 1×LTF, the OFDM symbol may be an HE/EHT/UHR 20 MHz 1×LTF symbol.

The 4 us OFDM symbol may take other forms depending on a number of frequency bins in which a data sequence is loaded. Less than all of the frequency bins may be loaded with a respective data of the data sequence to form the 4 us OFDM symbol.

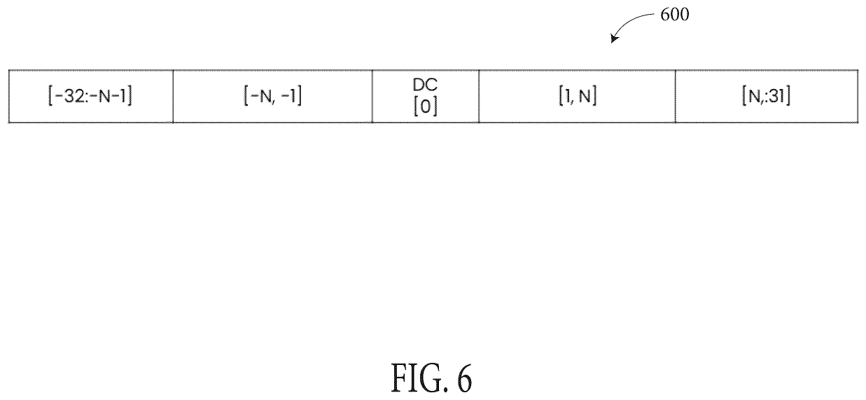

FIG. 6 illustrates an example plurality of frequency bins 600 corresponding to subcarriers of an OFDM symbol in accordance with one or more embodiments. In the example, 64 frequency bins 600 entries may correspond to 64 subcarriers of an OFDM symbol and a center N entries between-N and N may be loaded with the data sequence, where N ranges from 0 to 64. Bins between-N to N may be associated with a partially loaded data sequence to define the 4 us OFDM symbols of the waveform 128. In an example N=16.

In one or more embodiments, the carrier symbols may be based on a 16 us OFDM symbol. Data of a data sequence may be loaded into a respective frequency bin and an inverse Fast Fourier Transform of the data sequence in the frequency bins may be performed to generate a time domain OFDM symbol. When the data sequence is a HE-LTF, the OFDM symbol may be an HE-LTF 20 MHz symbol. Less than all of the frequency bins may be loaded with a respective data of the data sequence to form the 16 us OFDM symbol. The total number of subcarriers in this example is 256 instead of 64 as illustrated in FIG. 6 and subcarriers between-N to N may be modulated with a partially loaded data sequence to define the 16 us OFDM symbols of the waveform 128. In an example, N=64.

In one or more embodiments, the OFDM symbol may be a 1.6 us OFDM symbol. A trigger based HE STF may include 5 periods of 1.6 us. The frequency bins may be loaded with data of a respective period of the HE STF data sequence to define an OFDM symbol and a plurality of such OFDM symbols in the AMP portion of the PPDU further define an trigger based (TB) HE STF 20 MHz symbol. Further, if the total number of OOK symbols to modulate on a waveform of the carrier symbols is not multiple of 5, then the last symbol may be partially transmitted or padded to an end of the TB HE STF OFDM symbol.

In one or more embodiments, the OFDM symbol may be a 0.8 us OFDM symbol. An L-STF may include 5 periods of 0.8 us. The frequency bins may be loaded by data of a respective period of the HE STF data sequence to define an OFDM symbol and a plurality of such OFDM symbols in the AMP portion of the PPDU further define an L-STF symbol. An HT/VHT-STF may include 5 periods of 0.8 us. The frequency bins may be loaded by data of a respective period of the HE STF data sequence to define an OFDM symbol and a plurality of such OFDM symbols in the AMP portion of the PPDU further define an HT/VHT-STF symbol. An HE-STF may include 5 periods of 0.8 us or 16 periods of 0.8 us. The frequency bins 600 may be loaded by data of a respective period of the HE STF data sequence to define an OFDM symbol and a plurality of such OFDM symbols in the AMP portion of the PPDU further define a HE-STF symbol. Further, if the total number of OOK symbols to modulate on a waveform of the carrier symbols is not multiple of 5 or 16, then the last symbol may be partially transmitted or padded to an end of the OFDM symbol.

In one or more embodiments, the OFDM symbol may be a 2 us OFDM symbol. The OFDM symbol may be 2xVHT_LTF+0.4 us GI (guard interval) where only frequency bins corresponding to even tones are loaded with values of a VHT LTF sequence followed by using a first half of an inverse fast Fourier transform of the bins for a time domain representation of the OFDM symbol. The OFDM symbol may be 2xHE_LTF+0.4 us GI where frequency bins corresponding to every 8th tones are loaded with values of a HE LTF sequence followed by using a first half of an inverse fast Fourier transform of the bins for a time domain representation of the OFDM symbol. The OFDM symbol may be based on a 32 length sequence+0.4 GI where only frequency bins corresponding to values of the 32 length sequence are loaded and a 32 size IFFT is defined. In some embodiments, a sequence may be partially loaded in the bins, e.g., N=16 for an IFFT size of 256 subcarriers.

In one or more embodiments, the OFDM symbol may be a 0.5 us OFDM symbol. The OFDM symbol may be 8xVHT_LTF+0.lus GI (guard interval) where frequency bins corresponding to every 8 tones is loaded with values of a VHT LTF sequence followed by using a first half of an inverse fast Fourier transform of the bins for a time domain representation of the OFDM symbol. The OFDM symbol may be 32xHE_LTF+0.1 us GI where frequency bins corresponding to every 32th tone are loaded with values of a HE LTF sequence followed by using a first half of an inverse fast Fourier transform of the bins for a time domain representation of the OFDM symbol. The OFDM symbol may be based on a 8 length sequence+0.1 GI where only frequency bins corresponding to values of the 8 length sequence are loaded and a 8 size IFFT is defined. In some embodiments, a sequence may be partially loaded in the bins 600, e.g., N=16 for IFFT size of 256 subcarriers.

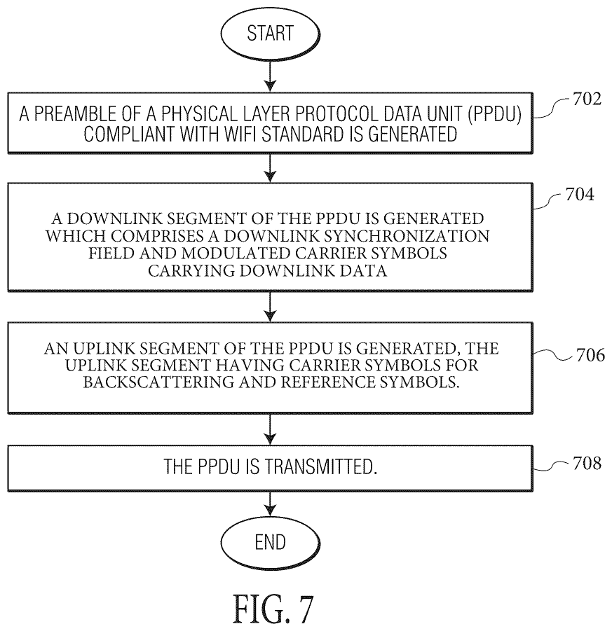

FIG. 7 is an example flow chart 700 of functions associated with the WiFi reader generating and transmitting an PPDU to an AMP tag device in accordance with one or more embodiments. At 702, a preamble of a physical layer protocol data unit (PPDU) compliant with the WiFi standard is generated. The preamble may be a legacy 802.11 preamble, either 802.11b or an OFDM preamble followed by an AMP portion of the PPDU which is the payload of the PPDU. At 704, a downlink segment of the PPDU is generated to transmit data to an AMP tag device and includes a downlink synchronization field and carrier symbols which are modulated by the WiFi reader to carry downlink data. At 706, an uplink segment of the PPDU is generated, the uplink segment having reference symbols which the WiFi reader uses to performs signal leakage estimation and carrier symbols, wherein the AMP tag device is arranged to backscatter a waveform based on the carrier symbols. The WiFi reader 102 does not modulate the carrier symbols in the uplink segment to carry data and the AMP tag device may modulate a waveform of the carrier symbols in the uplink segment to transmit uplink data to the WiFi reader by backscattering. At 708, the PPDU is transmitted. Based on a leakage signal estimation performed by the WiFi reader 102, the signal leakage from transmitter to receiver may be subtracted from a received signal to recover the backscattered signal transmitted by the AMP tag device 122.

In one or more first embodiments, a method for communicating with an ambient power (A M P) tag device by an AMP-compliant WiFi reader is disclosed. The method comprises generating a preamble of a physical layer protocol data unit (PPDU), the preamble compliant with Institute of Electrical and Electronics Engineers (IEEE) 802.11; generating a downlink segment of the PPDU, wherein the downlink segment comprises a downlink synchronization field and modulated carrier symbols carrying downlink data; generating an uplink segment of the PPDU, wherein the uplink segment comprises reference symbols which the WiFi reader uses to performs signal leakage estimation and carrier symbols, wherein the AMP tag device is arranged to backscatter a waveform based on the carrier symbols; and transmitting, by the WiFi reader, the PPDU to the AMP tag device. In one or more embodiments, the preamble is compliant with a preamble defined by Institute of Electrical and Electronics Engineers (IEEE) 802.11b or an orthogonal frequency division multiplexed (OFDM) preamble compliant with IEEE 802.11g/n/ac/ax/be. In one or more embodiments, the OFDM preamble comprises a legacy short training field (L-STF), a legacy long training field (L-LTF), a legacy signaling field (L-SIG), a repeated legacy signaling field (RL-SIG), and a universal signaling field (U-SIG). In one or more embodiments, a universal signal (U-SIG) field of the preamble comprises a validate mode or a PHY version value to indicate that the PPDU is associated with AMP communication. In one or more embodiments, the downlink and uplink segments are defined by a carrier waveform with repeated same carrier symbols with additional per-symbol phase or polarity. In one or more embodiments, a phase or polarity of carrier symbols is randomized. In one or more embodiments, the reference symbols have a pre-defined per-symbol phase or polarity. In one or more embodiments, a carrier waveform which defines the downlink and uplink segment are based on OFDM symbols. In one or more embodiments, the OFDM symbols are long training field (LTF) symbols. In one or more embodiments, the OFDM symbols are 4 us waveforms defined by L-LTF or HT/VHT LTF. In one or more embodiments, the OFDM symbols are based on duration of 1.6 us waveform defined by a trigger based HE STF. In one or more embodiments, the carrier symbols are based on OFDM symbols defined by a data sequence loaded in subset of frequency bins defining subcarriers of an OFDM symbol. In one or more embodiments, a carrier waveform for downlink and uplink segment are based on a direct spread spectrum (DSSS) waveform generated based on application of a spreading code and has a bandwidth equal or less than 22 MHz. In one or more embodiments, the PPDU includes additional carrier symbols before the downlink segment to energize the AMP tag. In one or more embodiments, the PPDU co-exists with WiFi communication. In one or more embodiments, the carrier symbols in the uplink segment are not modulated with data by the WiFi reader. In one or more embodiments, the method further includes detecting, by the WiFi reader, a uplink symbol boundary in a waveform that is backscattered based on a correlation filter with a duration being a function of a symbol duration of the carrier symbol and a maximum parts per million (ppm) modulation variation of the AMP tag device. In one or more embodiments, the preamble indicates a length of the PPDU which includes both the downlink segment and the uplink segment. In one or more embodiments, the uplink segment further includes an uplink preamble that precedes the carrier symbols to indicate a start of backscattering.

In one or more second embodiments, a WiFi reader is disclosed. The WiFi reader is arranged to generate a preamble of a physical layer protocol data unit (PPDU), the preamble compliant with Institute of Electrical and Electronics Engineers (IEEE) 802.11; generating a downlink segment of the PPDU, wherein the downlink segment comprises a downlink synchronization field and modulated carrier symbols carrying downlink data; generate an uplink segment of the PPDU, wherein the uplink segment comprises reference symbols which the WiFi reader uses to performs signal leakage estimation and carrier symbols, and wherein an AMP tag device is arranged to backscatter a waveform based on the carrier symbols; and transmit, by the WiFi reader, the PPDU to the AMP tag device. In one or more embodiments, a universal signal (U-SIG) field of the preamble comprises a validate mode or a PHY version value to indicate that the PPDU is associated with A M P communication. In one or more embodiments, the WiFi reader is arranged to detect a uplink modulated symbol boundary in a waveform that is backscattered based on a correlation filter with a duration being a function of a symbol duration of the carrier symbol and a maximum parts per million (ppm) modulation variation of the AMP tag device. In one or more embodiments, the uplink segment further includes an uplink preamble that precedes the carrier symbols to indicate a start of backscattering. In one or more embodiments, the carrier symbols are based on OFDM symbols defined by a data sequence loaded in subset of frequency bins defining subcarriers of the OFDM symbol. In one or more embodiments, the carrier symbols are 4 us waveforms defined by L-LTF or HT/VHT LTF or based on duration of 1.6 us waveform defined by a trigger based HE STF. In one or more embodiments, the PPDU includes additional carrier symbols before the downlink segment to energize the A M P tag device.

A few implementations have been described in detail above, and various modifications are possible. The disclosed subject matter, including the functional operations described in this specification, can be implemented in electronic circuit, computer hardware, firmware, software, or in combinations of them, such as the structural means disclosed in this specification and structural equivalents thereof: including potentially a program operable to cause one or more content processing apparatus such as a processor to perform the operations described (such as a program encoded in a non-transitory computer-readable communication medium, which can be a memory device, a storage device, a machine-readable storage substrate, or other physical, machine readable communication medium, or a combination of one or more of them).

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed. Other implementations fall within the scope of the following claims.

What is claimed is:

1. A method for communicating with an ambient power (AMP) tag device by an AMP-compliant WiFi reader, the method comprising:
generating a preamble of a physical layer protocol data unit (PPDU), the preamble compliant with Institute of Electrical and Electronics Engineers (IEEE) 802.11;
generating a downlink segment of the PPDU, wherein the downlink segment comprises a downlink synchronization field and modulated carrier symbols carrying downlink data;
generating an uplink segment of the PPDU, wherein the uplink segment comprises reference symbols which the WiFi reader uses to performs signal leakage estimation and carrier symbols, wherein the AMP tag device is arranged to backscatter a waveform based on the carrier symbols; and
transmitting, by the WiFi reader, the PPDU to the AMP tag device.

2. The method of claim 1, wherein the preamble is compliant with a preamble defined by Institute of Electrical and Electronics Engineers (IEEE) 802.11b or an orthogonal frequency division multiplexed (OFDM) preamble compliant with IEEE 802.11g/n/ac/ax/be.

3. The method of claim 2, wherein the OFDM preamble comprises a legacy short training field (L-STF), a legacy long training field (L-LTF), a legacy signaling field (L-SIG), a repeated legacy signaling field (RL-SIG), and a universal signaling field (U-SIG).

4. The method of claim 1, wherein a universal signal (U-SIG) field of the preamble comprises a validate mode or a PHY version value to indicate that the PPDU is associated with AMP communication.

5. The method of claim 1, wherein the downlink and uplink segments are defined by a carrier waveform with repeated same carrier symbols with additional per-symbol phase or polarity.

6. The method of claim 5, wherein a phase or polarity of carrier symbols is randomized.

7. The method of claim 5, wherein the reference symbols have a pre-defined per-symbol phase or polarity.

8. The method of claim 1, wherein a carrier waveform which defines the downlink and uplink segment are based on OFDM symbols.

9. The method of claim 8, wherein the OFDM symbols are long training field (LTF) symbols.

10. The method of claim 8, wherein the OFDM symbols are 4 us waveforms defined by L-LTF or HT/VHT LTF.

11. The method of claim 8, wherein the OFDM symbols are based on duration of 1.6 us waveform defined by a trigger based HE STF.

12. The method of claim 8, wherein the carrier symbols are based on OFDM symbols defined by a data sequence loaded in subset of frequency bins defining subcarriers of an OFDM symbol.

13. The method of claim 1, a carrier waveform for downlink and uplink segment are based on a direct spread spectrum (DSSS) waveform generated based on application of a spreading code and has a bandwidth equal or less than 22 MHz.

14. The method of claim 1, wherein the PPDU includes additional carrier symbols before the downlink segment to energize the AMP tag.

15. The method of claim 1, wherein the carrier symbols in the uplink segment are not modulated with data by the WiFi reader.

16. The method of claim 1, further comprising detecting, by the WiFi reader, a uplink symbol boundary in a waveform that is backscattered based on a correlation filter with a duration being a function of a symbol duration of the carrier symbol and a maximum parts per million (ppm) modulation variation of the AMP tag device.

17. The method of claim 1, wherein the preamble indicates a length of the PPDU which includes both the downlink segment and the uplink segment.

18. The method of claim 1, wherein the uplink segment further includes an uplink preamble that precedes the carrier symbols to indicate a start of backscattering.

19. A WiFi reader arranged to:
generate a preamble of a physical layer protocol data unit (PPDU), the preamble compliant with Institute of Electrical and Electronics Engineers (IEEE) 802.11;
generate a downlink segment of the PPDU, wherein the downlink segment comprises a downlink synchronization field and modulated carrier symbols carrying downlink data;
generate an uplink segment of the PPDU, wherein the uplink segment comprises reference symbols which the WiFi reader uses to performs signal leakage estimation and carrier symbols, and wherein an AMP tag device is arranged to backscatter a waveform based on the carrier symbols; and
transmit, by the WiFi reader, the PPDU to the AMP tag device.

20. The WiFi reader of claim 19, wherein a universal signal (U-SIG) field of the preamble comprises a validate mode or a PHY version value to indicate that the PPDU is associated with AMP communication.

21. The WiFi reader of claim 19, further comprising the WiFi reader arranged to detect a uplink modulated symbol boundary in a waveform that is backscattered based on a correlation filter with a duration being a function of a symbol duration of the carrier symbol and a maximum parts per million (ppm) modulation variation of the AMP tag device.

22. The WiFi reader of claim 19, wherein the uplink segment further includes an uplink preamble that precedes the carrier symbols to indicate a start of backscattering.

23. The WiFi reader of claim 19, wherein the carrier symbols are based on OFDM symbols defined by a data sequence loaded in subset of frequency bins defining subcarriers of the OFDM symbol.

24. The WiFi reader of claim 19, wherein the carrier symbols are 4 us waveforms defined by L-LTF or HT/VHT LTF or based on duration of 1.6 us waveform defined by a trigger based HE STF.

25. The WiFi reader of claim 19, wherein the PPDU includes additional carrier symbols before the downlink segment to energize the AMP tag device.
